(19) United States
(12) Patent Application Publication
(10) Pub. No.: US 2015/0300261 A1
(43) Pub. Date: Oct. 22, 2015

(54) FUEL HEATING SYSTEM FOR USE WITH A COMBINED CYCLE GAS TURBINE

(71) Applicant: General Electric Company, Schenectady, NY (US)

(72) Inventors: Kihyung Kim, Atlanta, GA (US); Dean Matthew Erickson, Simpsonville, SC (US); Diego Fernando Rancruel, Greenville, SC (US); Leslie Yung-Min Tong, Roswell, GA (US)

(73) Assignee: General Electric Company, Schenectady, NY (US)

(21) Appl. No.: 14/255,437

(22) Filed: Apr. 17, 2014

(51) Int. Cl. F02C 7/224; F01K 9/00; F01K 23/10

(52) U.S. Cl. CPC F02C 7/224; F01K 23/101; F01K 9/003

(57) ABSTRACT

A fuel heating system for use with a combined cycle gas turbine including a turbine outlet configured to channel a flow of exhaust gas towards a heat recovery steam generator is provided. The system includes a heat exchanger configured to channel a flow of fuel therethrough, and a plurality of heat transfer devices that each include an evaporator portion in thermal communication with the flow of exhaust gas and a condenser portion selectively thermally exposed to the flow of fuel. Each of the plurality of heat transfer devices are configured to conduct different grade heat from the exhaust gas to regulate a temperature of the fuel.

### BACKGROUND

The present disclosure relates generally to combined cycle power generation systems and, more specifically, to a system for use in heating fuel in a combined cycle gas turbine.

At least some known power generation systems include a multi-stage heat recovery steam generator (HRSG) that uses combustion exhaust gas to generate progressively lower grade steam from each successive stage. Relatively high grade heat at an exhaust gas inlet to the HRSG is capable of generating relatively high pressure steam in a high pressure stage or section of the HRSG. After heat is removed from the exhaust gas in the high pressure stage, the exhaust gas is channeled to an intermediate pressure stage where the relatively cooler exhaust gas is capable of generating a relatively lower pressure or intermediate pressure steam. The exhaust gas is then channeled to a low pressure stage of the HRSG to generate a low pressure steam.

At least some known power generation systems also, either directly or indirectly, use the exhaust gas to facilitate preheating fuel for use in a combined cycle gas turbine for use in enhancing thermal efficiency. A temperature of the exhaust gas may vary as a function of an operating condition of the gas turbine and/or a location of the exhaust gas along the multi-stage HRSG. As such, it may be difficult to regulate a temperature of the fuel to within a predetermined temperature range.

### BRIEF DESCRIPTION

In one aspect, a fuel heating system for use with a combined cycle gas turbine including a turbine outlet configured to channel a flow of exhaust gas towards a heat recovery steam generator is provided. The system includes a heat exchanger configured to channel a flow of fuel therethrough, and a plurality of heat transfer devices that each include an evaporator portion in thermal communication with the flow of exhaust gas and a condenser portion selectively thermally exposed to the flow of fuel. Each of the plurality of heat transfer devices are configured to conduct different grade heat from the exhaust gas to regulate a temperature of the fuel.

In another aspect, a combined cycle power generation system is provided. The system includes a gas turbine comprising a turbine outlet, a heat recovery steam generator configured to receive a flow of exhaust gas discharged from the turbine outlet, and a fuel heating system. The fuel heating system includes a heat exchanger configured to channel a flow of fuel therethrough, and a plurality of heat transfer devices that each include an evaporator portion in thermal communication with the flow of exhaust gas and a condenser portion selectively thermally exposed to the flow of fuel. Each of the plurality of heat transfer devices are configured to conduct different grade heat from the exhaust gas to regulate a temperature of the fuel.

In yet another aspect, a method of assembling a fuel heating assembly for use in a combined cycle power generation system that includes a gas turbine and a heat recovery steam generator configured to receive a flow of exhaust gas discharged from the gas turbine is provided. The method includes providing a heat exchanger configured to channel a flow of fuel therethrough, and coupling a plurality of heat transfer devices in thermal communication between the heat recovery steam generator and the heat exchanger. The coupling includes coupling first ends of the plurality of heat transfer devices in thermal communication with the flow of exhaust gas, and coupling second ends of the plurality of heat transfer devices in thermal communication with the flow of fuel. The first ends define evaporative portions of the plurality of heat transfer devices, and the second ends define condenser portions of the plurality of heat transfer devices configured to be selectively thermally exposed to the flow of fuel. Each of the plurality of heat transfer devices are configured to conduct different grade heat from the exhaust gas to regulate a temperature of the fuel.

### BRIEF DESCRIPTION OF THE DRAWINGS

FIG. 1 is a schematic illustration of an exemplary combined cycle power generation system.

FIG. 2 is a schematic illustration of an exemplary fuel heating system in a first operational mode that may be used with the combined cycle power generation system shown in FIG. 1.

FIG. 3 is a schematic illustration of the fuel heating system shown in FIG. 2 in a second operational mode.

FIG. 4 is a schematic illustration of an alternative fuel heating system that may be used with the combined cycle power generation system shown in FIG. 1.

### DETAILED DESCRIPTION

Embodiments of the present disclosure relate to power generation systems that include an integrated fuel heating system for use in preheating fuel directed towards a gas turbine. In the exemplary embodiment, the fuel heating system includes a plurality of heat transfer devices coupled in thermal communication between a heat recovery steam generator (HRSG) of the power generation system and a heat exchanger channeling a flow of fuel therethrough. Specifically, evaporator portions of the heat transfer devices are positioned at different axial locations along the HRSG such that the heat transfer devices are exposed to hot exhaust gas of varying temperature channeled through the HRSG. The flow of fuel is channeled past condenser portions of the heat transfer devices such that different grade heat is transferred to the fuel. Moreover, the heat transfer devices are selectively thermally exposed to the flow of fuel to facilitate regulating a temperature of the fuel. As such, the temperature regulation facilitates increasing and/or maintaining the temperature of the fuel within a predetermined temperature range.

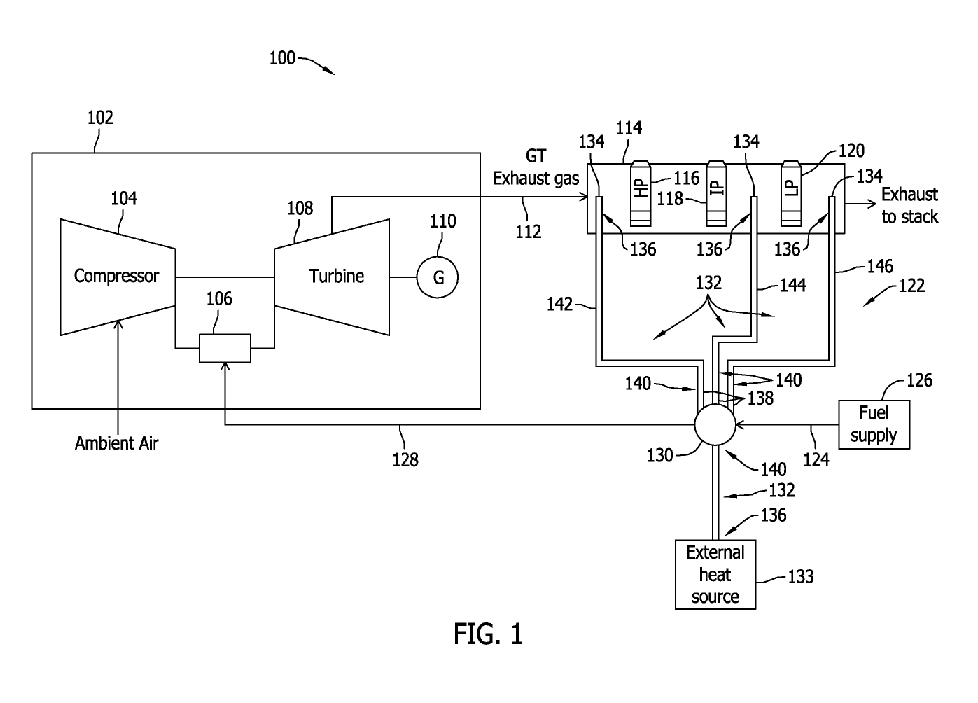

FIG. 1 is a schematic illustration of an exemplary combined cycle power generation system 100. Power generation system 100 includes a gas turbine engine assembly 102 that includes a compressor 104, a combustor 106, and a turbine 108 powered by expanding hot gas produced in combustor 106 for driving an electrical generator 110. Exhaust gas 112 is channeled from turbine 108 towards a heat recovery steam generator (HRSG) 114 for recovering waste heat from the exhaust gas. HRSG 114 includes a high pressure (HP) steam section 116, an intermediate pressure (IP) steam section 118, and a low pressure (LP) steam section 120. HRSG 114 transfers progressively lower grade heat from the exhaust gas to water/steam circulating through each progressively lower pressure section. Each of HP, IP, and LP sections 116, 118, and 120 may include an economizer, an evaporator, a superheater or other pre-heaters associated with the respective section, such as but not limited to a high pressure section pre-heater, which may be split into multiple heat exchangers. In an alternative embodiment, HRSG 114 may have any number of pressure sections that enables power generation system 100 to function as described herein. Moreover, alternatively,

Power generation system 100 also includes a fuel heating system 122 that preheats a flow of fuel 124 channeled from a fuel supply 126 towards fuel heating system 122. More specifically, fuel heating system 122 facilitates regulating a temperature of fuel 124 such that a flow of preheated fuel 128 is channeled towards combustor 106. Fuel heating system 122 includes a heat exchanger 130 coupled in flow communication between combustor 106 and fuel supply 126, and a plurality of heat transfer devices 132 coupled in thermal communication between HRSG 114 and heat exchanger 130, as will be described in more detail below. Moreover, in one embodiment, fuel heating system includes an external heat source 133 and a heat transfer device 132 coupled in thermal communication between external heat source 133 and heat exchanger 130. Exemplary external heat sources include, but are not limited to, a generator cooling system, a renewable energy source, and waste heat from a steam cycle. As such, fuel heating system 122 facilitates preheating fuel channeled towards combustor 106 using thermal energy from exhaust gas 112 discharged from turbine 108 and flowing through HRSG 114.

Heat transfer devices 132 may be any heat transfer device that enables fuel heating system 122 to function as described herein. Exemplary heat transfer devices 132 include, but are not limited to, heat pipes (e.g., constant conductance, variable conductance, and/or pressure controlled), and thermosyphons. In the exemplary embodiment, each heat transfer device 132 includes a first end 134 defining an evaporator portion 136 and second end 138 defining a condenser portion 140. Evaporator portions 136 of each heat transfer device 132 are coupled in thermal communication with a flow of exhaust gas 112 channeled through HRSG 114, and condenser portions 140 are selectively thermally exposed to the flow of fuel 124 channeled through heat exchanger 130.

In the exemplary embodiment, heat transfer devices 132 conduct different grade heat from exhaust gas 112 to facilitate regulating the temperature of preheated fuel 128 channeled towards combustor 106. Specifically, fuel 124 is preheated to a predetermined temperature range. As described above, HRSG 114 transfers progressively lower grade heat from exhaust gas 112 to water/steam circulating through each progressively lower pressure section. As such, the grade of heat conducted by heat transfer devices 132 is based at least partially on an axial position of evaporator portions 136 of each heat transfer device 132 along HRSG 114. For example, in the exemplary embodiment, an evaporator portion 136 of a first heat transfer device 142 is positioned upstream from HP section 116, an evaporator portion 136 of a second heat transfer device 144 is positioned between IP section 118 and LP section 120, and an evaporator portion 136 of a third heat transfer device 146 is positioned downstream from LP section 120. As such, first, second, and third heat transfer devices 142, 144, and 146 conduct progressively lower grade heat from exhaust gas 112 as a distance between turbine 108 and respective evaporator portions 136 increases. While shown as including three heat transfer devices, any number of heat transfer devices located at any axial position along HRSG 114 may be included that enables fuel heating system 122 to function as described herein.

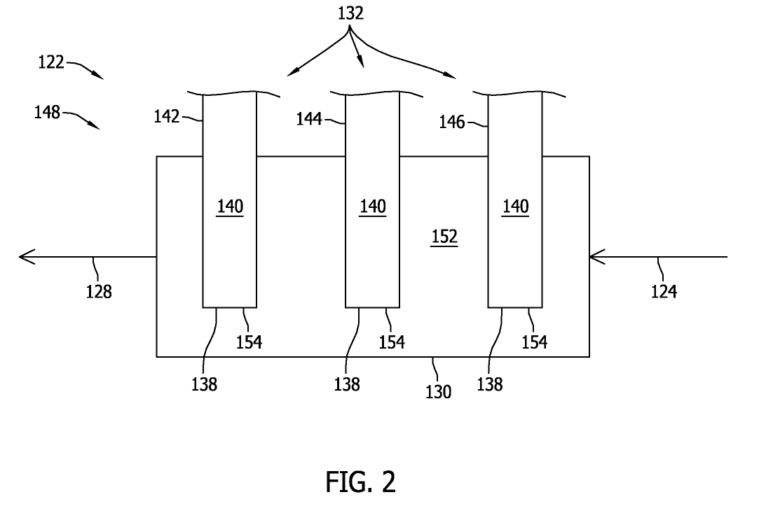

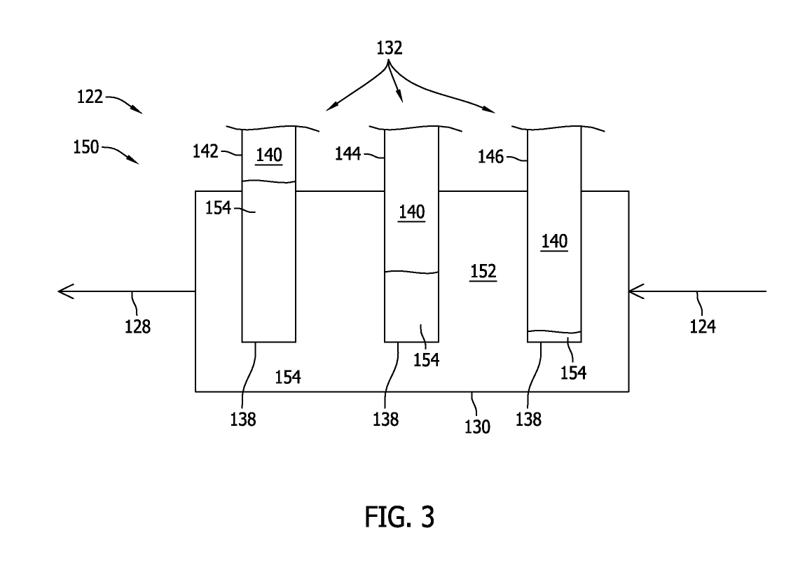

FIG. 2 is a schematic illustration of fuel heating system 122 in a first operational mode 148, and FIG. 3 is a schematic illustration of fuel heating system 122 in a second operational mode 150. In the exemplary embodiment, heat exchanger 130 is sized to receive second ends 138 of first, second, and third heat transfer devices 142, 144, and 146. More specifically, second ends 138 extend through an internal cavity 152 of heat exchanger 130 and fuel 124 is channeled through internal cavity 152 such that fuel 124 flows past each condenser portion 140. As such, fuel 124 channeled through heat exchanger 130 is heated to within the predetermined temperature range and discharged therefrom in the form of preheated fuel 128.

As described above, first, second, and third heat transfer devices 142, 144, and 146 transfer different grade heat from exhaust gas 112 to fuel 124 such that each heat transfer device 132 can only increase the temperature of fuel 124 by a predetermined amount. For example, in the exemplary embodiment, first heat transfer device 142 conducts the highest grade heat to increase the temperature of fuel 124 above the predetermined temperature range of preheated fuel 128, second heat transfer device 144 conducts intermediate grade heat to increase the temperature of fuel 124 above the predetermined temperature range of preheated fuel 128 by less than first heat transfer device 142, and third heat transfer device 146 conducts the lowest grade heat to increase the temperature of fuel 124 below the predetermined temperature range of preheated fuel 128. As such, and as will be described in more detail, condenser portions 140 of each heat transfer device 132 are selectively thermally exposed to fuel 124 to facilitate regulating the temperature of fuel 124. The selective exposure is based at least partially on an operational status of gas turbine 102 and/or a position of respective heat transfer devices 132 along HRSG 114. Moreover, lower grade heat is generally used first to increase the temperature of fuel 124 before higher grade heat is used, and the higher grade heat is used to regulate the temperature of fuel 124 to within the predetermined temperature range and/or to a target temperature.

In the exemplary embodiment, first, second, and third heat transfer devices 142, 144, and 146 are variable conductance heat pipes (not shown). More specifically, each heat transfer device 132 contains an amount of non-condensable gas (NCG) 154 therein. The amount of NCG 154 within each heat transfer device 132 is dynamically selected to vary the thermal conductance heat transfer devices 132 by blocking a portion of condenser portions 140 of each heat transfer device 132. For example, the thermal conductance of heat transfer devices 132 decreases as the amount of NCG 154 therein increases, and vice versa. As such, the selective exposure and heat transfer capabilities of condenser portions 140 are based at least partially on the amount of NCG 154 in each heat transfer device 132.

Referring to FIG. 2, fuel heating system 122 is in first operational mode 148 during startup of power generation system 100 (shown in FIG. 1). More specifically, in first operational mode 148, heat transfer devices 132 contain small amounts or no NCG 154 to enable heat to be extracted from each heat transfer device 132 by fuel 124. Allowing heat to be extracted from each heat transfer device 132 facilitates increasing the rate at which the temperature of fuel 124 can be increased to the predetermined temperature range and/or to a target temperature. Quickly increasing the temperature of fuel 124 to the predetermined temperature range facilitates increasing the efficiency of power generation system 100.

Referring to FIG. 3, fuel heating system 122 is in second operational mode 150 when power generation system 100 (shown in FIG. 1) is in steady state operation. As described above, first heat transfer device 142 can transfer the highest grade heat to fuel 124 relative to second and third heat transfer devices 144 and 146. In some embodiments, transferring the highest grade heat to fuel 124 will increase the temperature of preheated fuel 128 outside of the predetermined temperature range. As such, the amount of NCG 154 in each heat transfer device 132 is selected to facilitate regulating the temperature of preheated fuel 128 to within the predetermined temperature range.

For example, in the exemplary embodiment, a first amount of NCG 154 is in first heat transfer device 142, a second amount of NCG 154 that is less than the first amount is in second heat transfer device 144, and a third amount of NCG 154 that is less than the second amount is in third heat transfer device 146. As power generation system 100 transitions from startup to steady state operation, the amounts of NCG 154 in each heat transfer device 132 are varied to facilitate regulating the temperature of preheated fuel 128. More specifically, after preheated fuel 128 has reached the predetermined temperature range, the amounts of NCG 154 in one or more heat transfer devices 132 are increased to vary exposure of respective condenser portions 140 to fuel 124 and to facilitate reducing the amount of heat that fuel 124 can extract therefrom. For example, in second operational mode 150, the first amount of NCG 154 in first heat transfer device 142 is increased such that condenser portion 140 is blocked from transferring heat to fuel 124. Moreover, the amounts of NCG 154 in second and third heat transfer devices 144 and 146 are selected to vary exposure of respective condenser portions 140 to fuel 124.

In some embodiments, fuel 124 is directed past heat transfer devices 132 that conduct lower grade heat before being directed past heat transfer devices 132 that conduct comparatively higher grade heat. For example, in the exemplary embodiment, fuel 124 is directed past third heat transfer device 146, second heat transfer device 144, and then first heat transfer device 142. As such, heat is initially extracted from the lower pressure stages of HRSG 114 to facilitate reducing efficiency losses from higher pressure stages of HRSG 114.

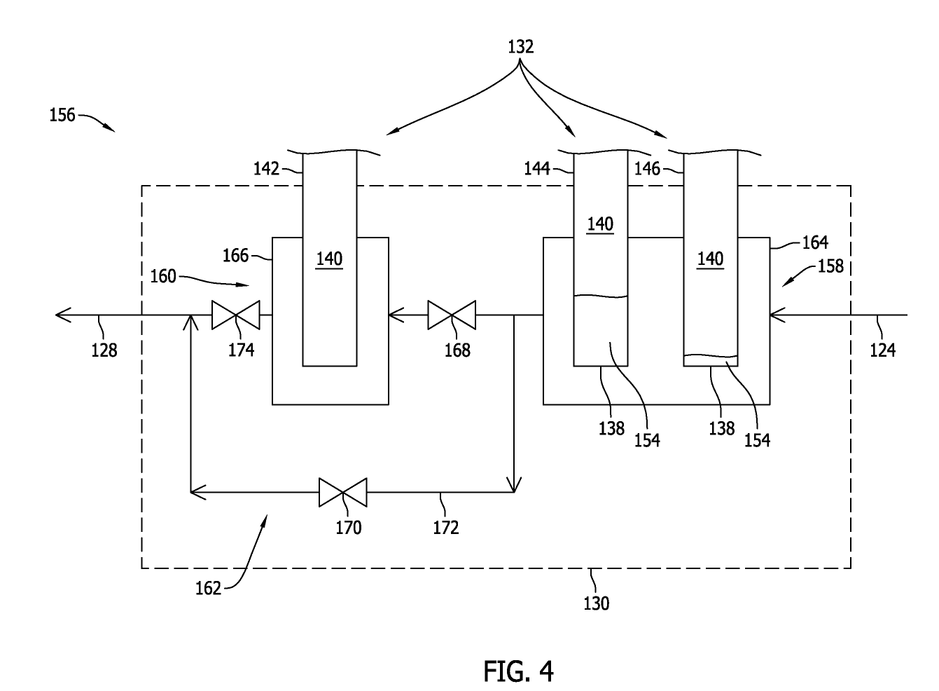

FIG. 4 is a schematic illustration of an alternative fuel heating system 156. In the exemplary embodiment, fuel heating system 156 includes a first heat exchange sub-assembly 158, a second heat exchange sub-assembly 160, and a valve system 162. First heat exchange sub-assembly 158 includes a first heat exchanger 164 sized to receive second ends 138 of second and third heat transfer devices 144 and 146, and second heat exchange sub-assembly 160 includes a second heat exchanger 166 sized to receive second end 138 of first heat transfer device 142. Second ends 138 of second and third heat transfer devices 144 and 146 are received within first heat exchanger 164 such that second heat transfer device 144 can supplement heating fuel 124 if third heat transfer device 146 is unable to increase the temperature of fuel 124 to the predetermined temperature range.

In the exemplary embodiment, valve system 162 includes a first valve 168 coupled in flow communication between first and second heat exchange sub-assemblies 158 and 160, a second valve 170 coupled in flow communication with a bypass conduit 172 downstream from first heat exchange sub-assembly 158, and a third valve 174 coupled in flow communication downstream from second heat exchange sub-assembly 160. Each valve in valve system 162 is selectively actuatable to selectively thermally expose second ends 138 and/or condenser portions 140 of heat transfer devices 132 to fuel 124 to facilitate regulating the temperature of preheated fuel 128.

In operation, valves in valve system 162 actuate such that fuel 124 is selectively directed past condenser portions 140 of respective heat transfer devices 132. For example, when power generation system 100 (shown in FIG. 1) is in startup mode, first and third valves 168 and 174 are open and second valve 170 is closed such that fuel 124 is channeled through both first and second heat exchange sub-assemblies 158 and 160. As such, fuel 124 is exposed to and allowed to extract heat from condenser portions 140 of each heat transfer device 132 to facilitate increasing the rate at which the temperature of fuel 124 can be increased to the predetermined temperature range of preheated fuel 128. As power generation system 100 transitions from startup to normal operation, first and third valves 168 and 174 are closed and second valve 170 opens such that fuel 124 discharged from first heat exchange sub-assembly 158 flows through bypass conduit 172 and away from second heat exchange sub-assembly 160. As such, fuel 124 is exposed to and allowed to extract heat only from condenser portions 140 of second and third heat transfer devices 144 and 146.

The systems and methods described herein facilitate regulating a temperature of fuel channeled towards a combined cycle gas turbine. In the exemplary embodiment, evaporative portions of heat transfer devices are positioned at different axial locations along a heat recovery steam generator (HRSG) such that turbine exhaust gas channeled therethrough is in thermal communication with the heat transfer devices. Because the heat transfer devices are positioned at different axial locations along HRSG, progressively lower grade heat is conducted as heat is extracted from stages in the HRSG. As such, progressively lower grade heat is transferred to a flow of fuel channeled past condenser portions of the heat transfer devices. Moreover, the temperature of the fuel may be regulated by selectively exposing condenser portions of the heat transfer devices to the flow of fuel. As such, the systems and methods described herein facilitate increasing the efficiency of combined cycle power generation systems by regulating fuel temperature in response to operational conditions of the power generation system.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fuel heating system for use with a combined cycle gas turbine including a turbine outlet configured to channel a flow of exhaust gas towards a heat recovery steam generator, said system comprising:
a heat exchanger configured to channel a flow of fuel therethrough; and
a plurality of heat transfer devices that each comprise an evaporator portion in thermal communication with the flow of exhaust gas and a condenser portion selectively thermally exposed to the flow of fuel, wherein each of said plurality of heat transfer devices are configured to conduct different grade heat from the exhaust gas to regulate a temperature of the fuel.

2. The system in accordance with claim 1, wherein evaporator portions of each said plurality of heat transfer devices are positioned at different axial locations along the heat recovery steam generator.

3. The system in accordance with claim 1, wherein each of said plurality of heat transfer devices are configured to conduct progressively lower grade heat from the exhaust gas as a distance between the turbine outlet and evaporator portions of said plurality of heat transfer devices increases.

4. The system in accordance with claim 1, wherein said heat exchanger is sized to receive condenser portions of said plurality of heat transfer devices.

5. The system in accordance with claim 1, wherein said plurality of heat transfer devices comprise at least one of a plurality of variable conductance heat pipes or a plurality of thermosyphons.

6. The system in accordance with claim 5, wherein said condenser portions are selectively exposed to the flow of fuel as a function of an amount of non-condensable gas in said at least one of a plurality of variable conductance heat pipes or a plurality of thermosyphons.

7. The system in accordance with claim 1, wherein said heat exchanger comprises a plurality of valves configured to selectively actuate such that the flow of fuel selectively flows past respective condenser portions of said plurality of heat transfer devices.

8. The system in accordance with claim 1, wherein said condenser portions are selectively exposed to the flow of fuel as a function of an operational status of the combined cycle gas turbine.

9. A combined cycle power generation system comprising:
a gas turbine comprising a turbine outlet;
a heat recovery steam generator configured to receive a flow of exhaust gas discharged from said turbine outlet; and
a fuel heating system comprising:
a heat exchanger configured to channel a flow of fuel therethrough; and
a plurality of heat transfer devices that each comprise an evaporator portion in thermal communication with the flow of exhaust gas and a condenser portion selectively thermally exposed to the flow of fuel, wherein each of said plurality of heat transfer devices are configured to conduct different grade heat from the exhaust gas to regulate a temperature of the fuel.

10. The system in accordance with claim 9, wherein evaporator portions of each said plurality of heat transfer devices are positioned at different axial locations along the heat recovery steam generator.

11. The system in accordance with claim 9, wherein each of said plurality of heat transfer devices are configured to conduct progressively lower grade heat from the exhaust gas as a distance between the turbine outlet and evaporator portions of said plurality of heat transfer devices increases.

12. The system in accordance with claim 9, wherein said heat exchanger is sized to receive condenser portions of said plurality of heat transfer devices.

13. The system in accordance with claim 9, wherein said plurality of heat transfer devices comprise at least one of a plurality of variable conductance heat pipes or a plurality of thermosyphons.

14. The system in accordance with claim 13, wherein said condenser portions are selectively exposed to the flow of fuel as a function of an amount of non-condensable gas in said at least one of a plurality of variable conductance heat pipes or a plurality of thermosyphons.

15. The system in accordance with claim 9, wherein said heat exchanger comprises a plurality of valves configured to selectively actuate such that the flow of fuel selectively flows past respective condenser portions of said plurality of heat transfer devices.

16. The system in accordance with claim 9, wherein said condenser portions are selectively exposed to the flow of fuel as a function of an operational status of the combined cycle gas turbine.

17. A method of assembling a fuel heating assembly for use in a combined cycle power generation system that includes a gas turbine and a heat recovery steam generator configured to receive a flow of exhaust gas discharged from the gas turbine, said method comprising:
providing a heat exchanger configured to channel a flow of fuel therethrough; and
coupling a plurality of heat transfer devices in thermal communication between the heat recovery steam generator and the heat exchanger, said coupling comprising:
coupling first ends of the plurality of heat transfer devices in thermal communication with the flow of exhaust gas, wherein the first ends define evaporative portions of the plurality of heat transfer devices; and
coupling second ends of the plurality of heat transfer devices in thermal communication with the flow of fuel, wherein the second ends define condenser portions of the plurality of heat transfer devices configured to be selectively thermally exposed to the flow of fuel, wherein each of the plurality of heat transfer devices are configured to conduct different grade heat from the exhaust gas to regulate a temperature of the fuel.

18. The method in accordance with claim 17 further comprising positioning the evaporator portions of the plurality of heat transfer devices at different axial locations along the heat recovery steam generator.

19. The method in accordance with claim 17, wherein coupling second ends comprises sizing the second ends for insertion into the heat exchanger.

20. The method in accordance with claim 17, wherein coupling a plurality of heat transfer devices comprises coupling a plurality of variable conductance heat pipes in thermal communication between the heat recovery steam generator and the heat exchanger.
